(19) United States
(12) Patent Application Publication
(10) Pub. No.: US 2009/0171863 A1
(43) Pub. Date: Jul. 2, 2009

(54) Symmetrical re-balancing system

(75) Inventor: Robert John Grant, Des Moines, IA (US)

Correspondence Address: Robert John Grant, 1709 East Kirkwood Ave, Des Moines, IA, 50320-1125, US

(73) Assignees: The Grant Research Corporation, Des Moines, IA (US); The Salvation Army, Des Moines, IA (US)

(21) Appl. No.: 12/006,033

(22) Filed: Dec. 31, 2007

(51) Int. Cl. G06Q 90/00

(52) U.S. Cl. 705/500

(57) ABSTRACT

This is a new investment strategy which involves a new way to make a possibly decent return at a low risk. The new part of this process involves purchasing a long (or ultra long) fund of some index from a fund family. Also it involves simultaneously purchasing a short (or ultra short) fund based on the same underlying index from the same fund family. This strategy seeks to exploit the difference in percentage gained by the winner compared with a lesser percentage loss of the loser. This strategy also involves the already existing arts of technical and fundamental analysis in order to rebalance at a time when enough of a gain can be realized and when it becomes clear that the funds will change direction forcing the investor to buy low and sell high.

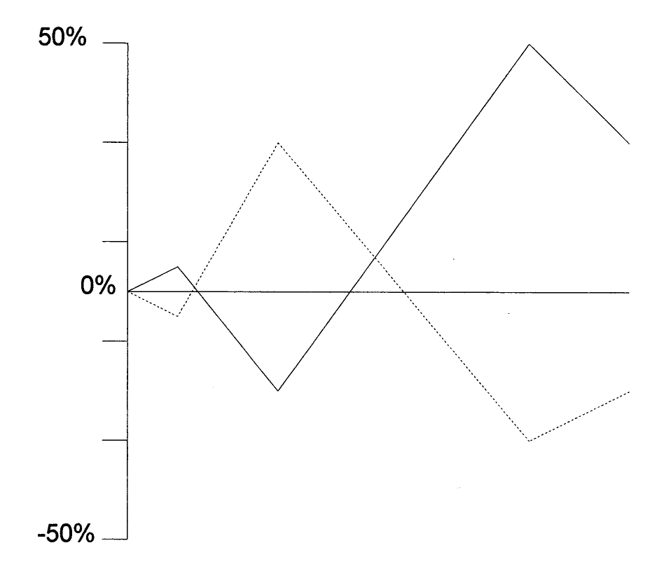

### BACKGROUND OF THE INVENTION

This is a system of investing which has the possible capability of producing high returns with a low probability of risk. This is similar to a hedge fund type of investment however it can be used by those with more modest means.

### SUMMARY OF THE INVENTION

This is a process which is comprised of three steps:

The first step involves purchasing any two funds within the same fund family in which one is a long fund (or ultra long fund) and the other is a short fund (or ultra short fund) of the same index making money by the difference of the price disparity over time.

The second step involves the use of technical analysis or fundamental analysis in order to determine the most likely time when the prices of both funds will reverse. This step is an already existing art.

The third step involves the use of re-balancing by selling off some of the winning position and purchase with those proceeds some more of the losing position. This step is also an already existing art. This final step forces the investor to buy low and sell high.

### DESCRIPTION OF THE DRAWING

The drawing itself is a waveform chart of two overlapping funds over the course of one year: one long and the other short. It doesn't matter which is which, just that they are opposite of each other.

### DETAILED DESCRIPTION OF THE INVENTION

This invention seeks to capitalize on the disparity in long and short funds which are based on the same index from within the same fund family. While this may seem too obvious, its the combination of the final two steps which make this invention more complex and less obvious. In fact the mathematics behind this invention are a bit more complex. This is because when a fund goes up, it goes up in parabolic motion with and unlimited potential for gain. But when a fund goes down, it cannot go down below zero. It's motion is hyperbolic. Now, often times the fund family manager will seek to attain the same percentage gain on one fund as the same percentage loss on the other. Therefore, as time progresses, the daily percentage gained from the winning fund will have a greater dollar value than the dollar value of the daily percentage loss from the losing fund.

That is, when it becomes time to rebalance, the winning side could go up by 50% while the losing side might only go down by 33%. After re-balancing, and when the two prices may come to where they were before, the formerly winning side will come down only 33% and the formerly losing side will go up 50%. If you were to overlay the prices of both funds together on the same chart, you would see that the lines of the price percentage comparison cross at 0% or within a few percentage points of that.

The main difference between this strategy and hedge funds is that hedge funds generally seek to hedge investments by using derivative instruments or short positions which can lose a lot of money when the underlying asset in those funds goes over double or more. When this happens, the part of the fund which seeks to profit from being short can lose enormous amounts of money. However, The Symmetrical Re-Balancing System only invests in funds which while one fund could, from the fund manager's perspective lose more than zero, the liability to the investor from his short fund will never go below zero. Only at that time the fund would then have to close. And the only way that would happen is if the underlying index in the fund doubled in one day. But on the other side, if that index did double in one day, all that money would be recuperated by the long fund. One nice advantage of re-balancing these funds is that each time the investor re-balances, he locks in a profit, plus or minus a small amount.

Another advantage that The Symmetrical Re-Balancing System has over hedge funds is that hedge funds can only be bought by the very wealthy, while the use of The Symmetrical Re-Balancing System can be done by those with a more modest means, even those with brokerage accounts with a balance of less than $2000.

Something now that I want to say about technical analysis and fundamental analysis is that as tools in and of themselves they may only work about 60% of the time. However, when they are combined with the long fund and short fund combination in order to rebalance, in that case, it really doesn't matter if it is right 60% of the time. This is because that at that time, the profits are locked in and the investor just starts the process over again. Another thing that I should mention is that while The Symmetrical Re-Balancing System may be very low risk, it is not zero. If an investor fails to rebalance at an appropriate time, the gains could be lost, however, it is unlikely that they will fall below the place where previously re-balanced.

1. This is the purchase of a long fund and simultaneously a short fund which are based upon the same index and from the same fund family in order to, after time, exploit the difference in percentage gained over percentage lost. These funds could also be ultra long and ultra short.

2. This is a claim which is dependent on claim (1). It involves the combination of claim (1) with the already existing arts known as technical analysis, fundamental analysis and re-balancing in order to maximize return on investment by re-balancing when it is believed that the funds will change direction. This is done to force the investor to buy low and sell high.
